(19) United States
(12) Patent Application Publication
(10) Pub. No.: US 2010/0095482 A1
(43) Pub. Date: Apr. 22, 2010

(54) HINGE

(75) Inventor: Wen-Bin Shen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,407

(22) Filed: Dec. 9, 2008

(30) Foreign Application Priority Data
Oct. 17, 2008 (CN) 200820302475.6

(51) Int. Cl. E05D 11/02; E05D 5/10

(52) U.S. Cl. 16/274; 16/386

(57) ABSTRACT

A hinge includes a sleeve, two bushings, and a shaft. The sleeve defines a mounting hole and a groove communicating with the mounting hole. Each bushing includes an inserting piece extending on a circumference thereof in an axial direction. A first end of the inserting piece juts out over a first end of the bushing. A second end of the inserting piece and a second end of the bushing together defines a cutout therebetween. The two bushings are received in the mounting hole with the inserting pieces inserted into the groove to fix the two bushings into the mounting hole. The first end of one bushing is engaged with the cutout of the other bushing. Each bushing defines a pivoting hole. The shaft is inserted in the pivoting holes of the two bushings and rotatable in the pivoting holes with respect to the sleeve.

### BACKGROUND

1. Technical Field

The disclosure relates to mechanical structures and, particularly, to a hinge.

2. Description of Related Art

A collapsible device, such as a notebook computer or a clamshell mobile phone, generally includes two parts pivotably connected via a hinge. The hinge generally includes a bracket mounted to one part and a shaft with one end mounted to the other part. The bracket includes a barrel rotatably receiving an opposite end of the shaft. A plurality of washers and a resilient assembly are retained around the shaft. The resilient assembly causes the plurality of washers to resist against the bracket and the shaft to increase friction when the hinge rotates, thereby positioning one part of the collapsible device with respect to the other part of the collapsible device at desired angles. However, over time, the resilient assembly may loosen, and cause noise when the hinge rotates.

Therefore, the present disclosure provides a hinge to obviate the described limitations.

### BRIEF DESCRIPTION OF THE DRAWINGS

FIG. 1 is an exploded, isometric view of an exemplary embodiment of a hinge and a bracket.

FIG. 2 is a partially enlarged view of the hinge of FIG. 1.

FIG. 3 is an assembled, isometric view of the hinge of FIG. 1.

FIG. 4 is a partially cutaway view of a part of FIG. 3.

### DETAILED DESCRIPTION

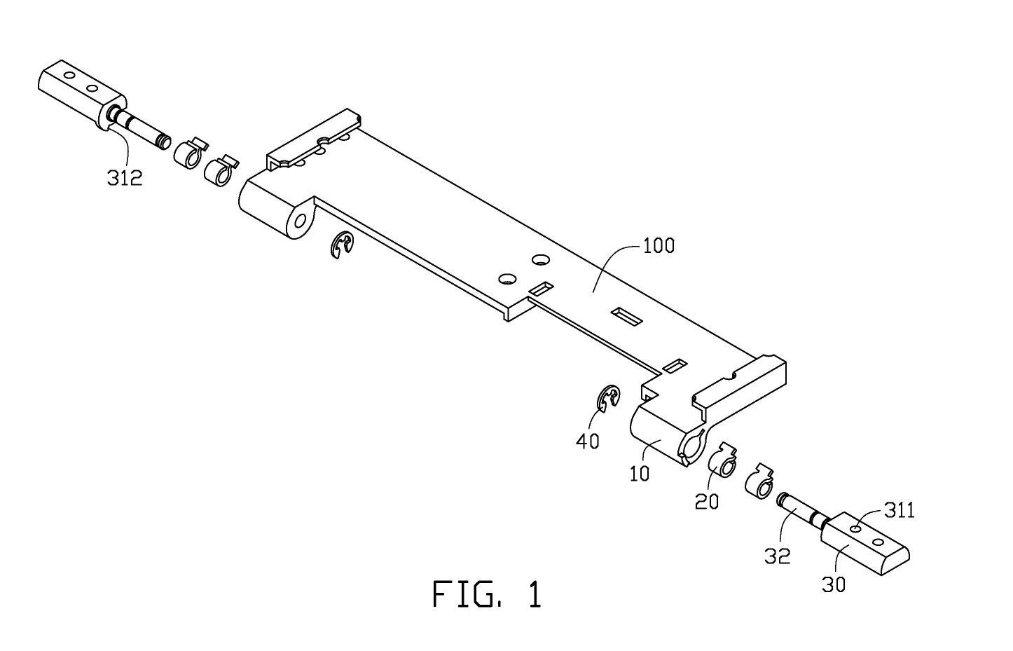

Referring to FIG. 1, an embodiment of a hinge is adapted to be mounted to a collapsible device, such as a notebook or a clamshell mobile phone, that includes two parts rotatably connected to each other via the hinge. The hinge includes a shaft 32, a sleeve 10, two constrictive bushings 20, and a fastener 40. The shaft 32 is fixed to a mounting board 30. The mounting board 30 defines a plurality of holes 311 therein to mount the mounting board 30 on one part of the collapsible device. The sleeve 10 is formed on a bracket 100, which is mounted on the other part of the collapsible device. In the illustrated embodiment, the bracket 100 forms two sleeves 10 thereon to engage with two hinges. In an alternative embodiment, the sleeve 10 can be a separate element mounted to the bracket 100 by conventional means, such as welding, riveting, and so on.

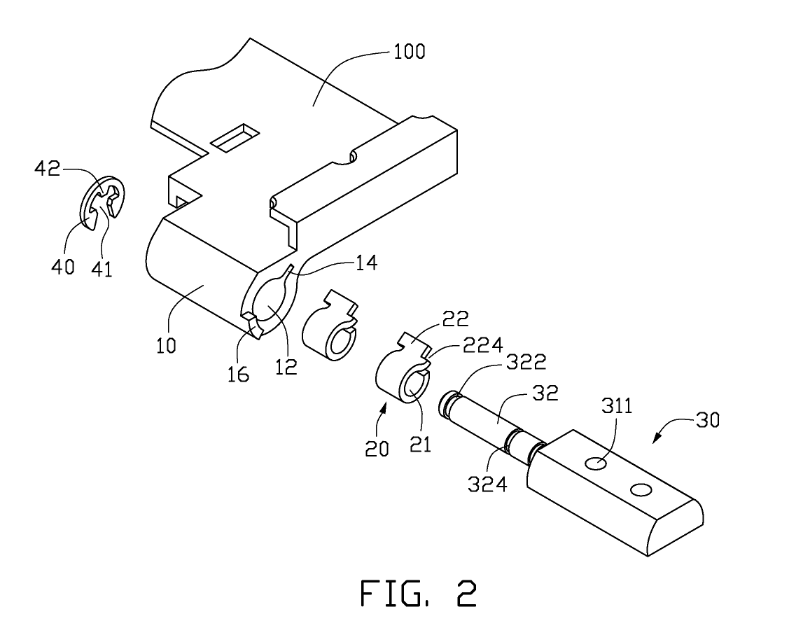

Referring to FIG. 2, the sleeve 10 defines an axial mounting hole 12. The sleeve includes an end surface facing the mounting board 30. A groove 14 is defined in the end surface, parallel to and communicating with the mounting hole 12. A block 16 protrudes from the end surface.

Each bushing 20 is cylindrical and hollow. An outer diameter of the bushing 20 is substantially equal to a diameter of the mounting hole 12. The bushing 20 axially defines a pivoting hole 21 therein. A slit (not labeled) is axially defined in the circumference of the bushing 20. Thus, the bushing 20 can be elastically constrictive. An inserting piece 22 is formed on the bushing 20 corresponding to the groove 14, for being inserted into the groove 14. The inserting piece 22 is extended in an axial direction from the bushing 20. A first end of the inserting piece 22 juts out of a first end of the bushing 20. A cutout 224 is defined between a second end of the inserting piece 22 and a second end of the bushing 20.

A first end of the shaft 32 is fixed to the mounting board 30. An engaging groove 322 is defined in the circumference of a second end of the shaft 32. Two receiving grooves 324 are defined in the circumference of the shaft 32, adjacent to the mounting board 30, for storing lubricant. The mounting board 30 forms a tab 312 (see FIG. 1) corresponding to the block 16 of the sleeve 10.

The fastener 40 has a substantially C-shaped contour, and defines a cutout 41 therein. A plurality of tenons 42 is extended from the fastener 40 into the cutout 41.

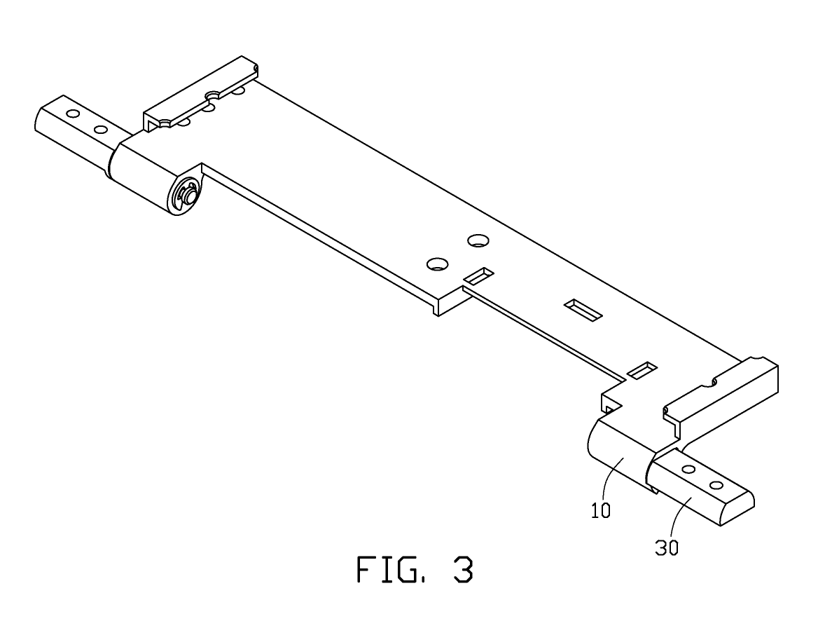

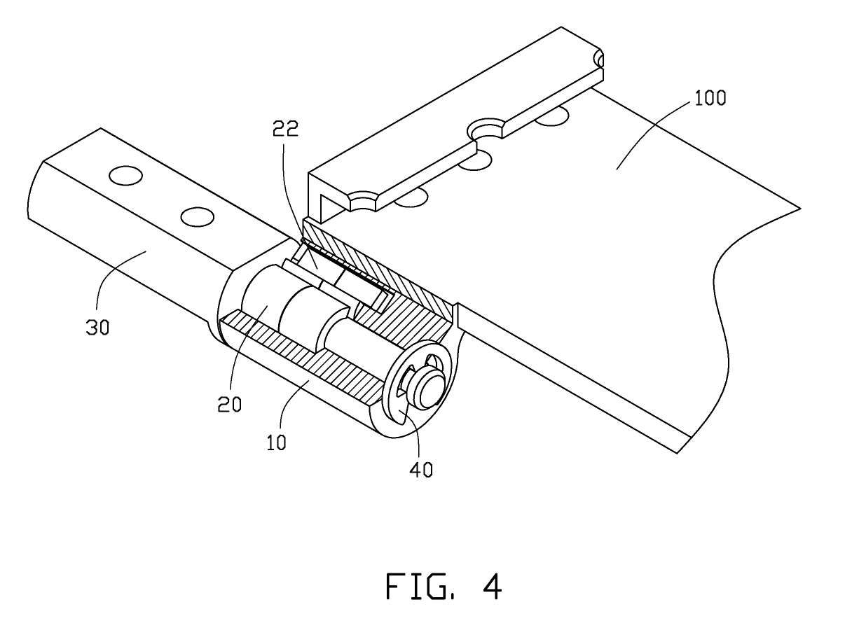

Referring to FIGS. 2 to 4, the two bushings 20 are constrictively inserted into the mounting hole 12, and the inserting pieces 22 are received in the groove 14 to fix the bushings 20 to the sleeve 10, wherein the first end of one of the inserting piece 22 is located in the cutout of the other inserting piece 22. The shaft 32 is inserted through the pivoting holes 21 of the two bushings 20, and the mounting hole 12 of the sleeve 10 from the end surface having the block 16. The engaging groove 322 of the shaft 32 is extended outside from the other end of the mounting hole 12 located at an end surface opposite to the mounting board 30. The fastener 40 is engaged in the engaging groove 322 of the shaft 32, with the tenons 42 tightly clutching the shaft 32, to prevent the shaft 32 from disengaging from the sleeve 10. In this position, the receiving grooves 324, which store lubricant therein, are positioned in the pivoting holes 21 of the bushings 20 respectively, to ensure smooth rotation of the shaft 32 in the pivoting holes 21. The shaft 32 rotates in the pivoting holes 21, until the tab 312 of the mounting board 30 resists against the block 16 of the sleeve 10.

In the hinge, because the bushings 20 are firmly mounted in the sleeve 10, the shaft 32 will not loosen relative to the sleeve 10. Thus, noise will not occur or be greatly reduced when the hinge rotates.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a sleeve defining a mounting hole and a groove communicating with the mounting hole;
two bushings each comprising an inserting piece extending on a circumference thereof in an axial direction, a first end of the inserting piece juts out over a first end of the bushing, and a second end of the inserting piece and a second end of the bushing together defines a cutout therebetween, wherein the two bushings are received in the mounting hole with the inserting pieces inserted into the groove to fix the two bushings into the mounting hole, the first end of one bushing is engaged with the cutout of the other bushing, each of the two bushings defines a pivoting hole; and
a shaft inserted in the pivoting holes of the two bushings and rotatable in the pivoting holes with respect to the sleeve.

2. The hinge of claim 1, wherein an outer diameter of each bushing is substantially equal to a diameter of the mounting hole.

3. The hinge of claim 1, wherein the shaft defines an engaging groove in a circumference thereof, the shaft is inserted through the mounting hole of the sleeve via the pivoting holes from a first end of the sleeve, with the engaging portion exposed on a second side of the sleeve, a fastener is engaged in the engaging groove to prevent the shaft from disengaging from the sleeve.

4. The hinge of claim 3, wherein the fastener defines a cutout, a plurality of tenons are extended from the fastener into the cutout, the shaft is inserted into the cutout and the tenons clutch on the shaft when the fastener is engaged in the engaging groove.

5. The hinge of claim 1, wherein the shaft defines one receiving groove to store lubricant therein, the receiving groove is positioned in one of the pivoting holes of the two bushings to smooth rotation of the shaft in the pivoting holes.

6. The hinge of claim 1, further comprising a mounting board, wherein the shaft is mounted to the mounting board, a tab extends from the mounting board, a block is formed on the sleeve, for resisting the tab to limit the rotation range of the shaft.

7. A hinge, comprising:
a sleeve defining a mounting hole;
at least one bushing immobile fixed in the mounting hole of the sleeve, each of the at least one bushing defining a pivoting hole; and
a shaft defining at least one receiving groove to store lubricant therein, the shaft rotatably inserted in each the pivoting hole with each receiving groove positioned in one of the pivoting holes to smooth rotation of the shaft in the pivoting hole.

8. The hinge of claim 7, wherein the sleeve further defines a groove communicating with the mounting hole, the at least one bushing each comprises an inserting piece inserted into the groove to fix the at least one bushing to the mounting hole.

9. The hinge of claim 8, wherein the at least one bushing comprises two bushings, the inserting piece is extended on a circumference of each bushing in an axial direction.

10. The hinge of claim 9, wherein a first end of each inserting piece protrudes out over a first end of a corresponding bushing, and a cutout is defined between a second end of the bushing and the inserting piece, the two bushings are inserted into the mounting hole with the first end of the inserting piece of one of the bushing engaged in the cutout of the other bushing.

11. The hinge of claim 7, wherein an outer diameter of each of the at least one bushing is substantially equal to a diameter of the mounting hole.

12. The hinge of claim 7, wherein the shaft further defines an engaging groove in a circumference thereof, the shaft is inserted through the mounting hole of the sleeve from a first end surface of the sleeve out of a second end surface of the sleeve, with the engaging portion exposed from the second end surface of the sleeve, a fastener is engaged in the engaging groove to mount the shaft on the sleeve.

13. The hinge of claim 12, wherein the fastener defines a cutout, a plurality of tenons are extended from the fastener into the cutout, the shaft is inserted into the cutout and the tenons clutch on the shaft when the fastener is engaged in the engaging groove.

14. The hinge of claim 7, further comprising a mounting board, wherein the shaft is mounted to an end of the mounting board, a tab is formed on the end of the mounting board, a block is formed on the sleeve for resisting against the tab to limit the rotation range of the shaft with respect to the sleeve.
